(19) United States
(12) Patent Application Publication
(10) Pub. No.: US 2015/0309836 A1
(43) Pub. Date: Oct. 29, 2015

(54) AVOIDING TRANSACTION ROLLBACK

(71) Applicant: International Business Machines Corporation, Armonk, NY (US)

(72) Inventors: Jiu Z. Han, Beijing (CN); Qi N. Li, Beijing (CN); Yi X. Song, Beijing (CN); Shuang Yu, Beijing (CN)

(21) Appl. No.: 14/697,992

(22) Filed: Apr. 28, 2015

Related U.S. Application Data
(63) Continuation-in-part of application No. 14/676,875, filed on Apr. 2, 2015.

(30) Foreign Application Priority Data
Apr. 29, 2014 (CN) 201410178265.0

(51) Int. Cl. G06F 9/46

(52) U.S. Cl. CPC G06F 9/466

(57) ABSTRACT

A method and apparatus for avoiding a transaction rollback is provided. The method includes determining, by a service status check unit, whether at least one available path exists through a logic flow during an execution of a transaction. The service status check unit forecasts a successful logic flow completion on the determining the existence of at least one available path through the logic flow. The transaction is terminated, based on there being no available path through the logic flow.

### BACKGROUND

The present invention relates to computer network applications, and more particularly, to avoiding rolling back a transaction.

Complex applications, such as online shopping applications, portal sites, and virtual malls, executing in a networked computer environment, often include a plurality of independent services, cooperating to execute as a transaction. In this context, the transaction may include a customer browsing goods on a website, viewing details about an item, selecting to purchase the item by initiating a checkout process, and finally, processing the order. Each of these portions of the transaction may be considered separate logic flows. Each logic flow may be further divided into one or more services that perform the logic flow. For example, the logic flow to process the order may further include services for reserving the inventory in the order, accepting and processing the payment information from the customer, and fulfilling the order.

The services may be provided by a local or remote service, i.e. from inside or outside of the business enterprise. For example, a credit card payment servicer may represent a remote service to a retail website. Orderly termination of a failed transaction may be costly, since identifying and rolling back the successful portions of the transaction may be required. For example, to rollback a customer purchase prior to completion may cost the merchant two service fees at the credit card payment servicer: one for the initial charge, and another to process a refund. Avoiding the redundant transactions may reduce costs and improve system performance for the merchant operating the website.

### SUMMARY OF THE INVENTION

A method and apparatus for avoiding a transaction rollback is provided. The method includes determining, by a service status check unit, whether at least one available path exists through a logic flow during an execution of a transaction. The method further provides forecasting, by the service status check unit, a successful logic flow completion based on the determined existence of at least one available path through the logic flow. The transaction is terminated, based on no available path through the logic flow.

In another embodiment, a computer program product for avoiding transaction rollback is provided. The computer program product includes a computer readable storage medium readable by a processing circuit and storing instructions for execution by the processing circuit for performing a method. The method includes determining, by a service status check unit, whether at least one available path exists through a logic flow during an execution of a transaction. The method further provides forecasting, by the service status check unit, a successful logic flow completion based on the determined existence of at least one available path through the logic flow. The transaction is terminated, based on no available path through the logic flow.

In a further embodiment, a computer system for avoiding transaction rollback is provided. The computer system includes a memory, a processing unit communicatively coupled to the memory, and a management module communicatively coupled to the memory and processing unit, wherein the management module is configured to perform the steps of a method. The method includes determining, by a service status check unit, whether at least one available path exists through a logic flow during an execution of a transaction. The method further provides forecasting, by the service status check unit, a successful logic flow completion based on the determined existence of at least one available path through the logic flow. The transaction is terminated, based on no available path through the logic flow.

In another embodiment, an apparatus for avoiding a transaction rollback is provided. The apparatus may include a service determining unit configured to, at a predetermined checkpoint in a business process which a currently executed transaction is in, determine at least one service included in subsequent processes of the checkpoint. The apparatus provides a service status querying unit configured to query at least one unavailable service in the at least one service included in the subsequent processes determined by the service determining unit. The apparatus provides a transaction executability judging unit configured to judge whether the transaction can be fulfilled based on the at least one unavailable service queried by the service status querying unit. The apparatus provides a transaction execution control unit configured to stop an execution of the transaction in response to a judgment of the transaction executability judging unit that the transaction cannot be fulfilled.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description.

FIG. 1 shows a block diagram of an exemplary computer system/server which is applicable to implement the embodiments of the present disclosure.

FIG. 2 shows a component diagram of a transaction rollback avoidance framework.

FIGS. 3-5 show alternative flowcharts of a ProcessOrder logic flow performed by the service status check module.

FIGS. 6-7 show exemplary logic flows having unavailable paths.

FIG. 8 shows a flowchart of a method for avoiding a transaction rollback according to embodiments of the present disclosure.

### DETAILED DESCRIPTION

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, aspects of the present invention may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit”, “module”, or “system”. Furthermore, aspects of the present invention may take the form of a computer program product embodied in one or more computer readable medium(s) having computer readable program code embodied thereon.

Aspects of the present disclosure are described below with reference to flowchart illustrations and/or block diagrams of methods, apparatus, (systems), and computer program products according to embodiments of the invention. It will be understood that each block of the flowchart illustrations and/or block diagrams, and combinations of blocks in the flowchart illustrations and/or block diagrams, can be implemented by computer program instructions.

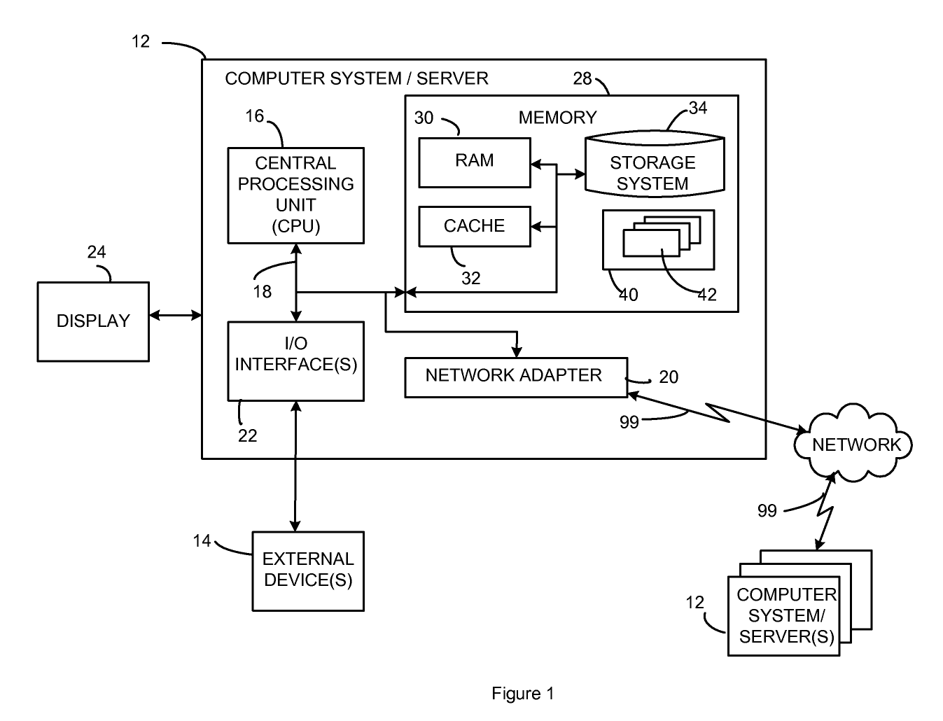

FIG. 1 is a block diagram of an exemplary computer system/server 12 operable for various embodiments of the present disclosure. Computer system/server 12 is only one example of a suitable computer for transaction rollback avoidance and is not intended to suggest any limitation as to the scope of use or functionality of embodiments of the invention described herein.

The server 12 is operational in numerous other computing system environments or configurations. For example, the server 12 may be a standalone machine, a virtual partition on physical host, a clustered server environment, or a distributed cloud computing environment that includes any of the above systems or devices, and the like. When practiced in a distributed cloud computing environment, tasks may be performed by both local and remote servers 12 that are linked together and communicate through a communications network 99.

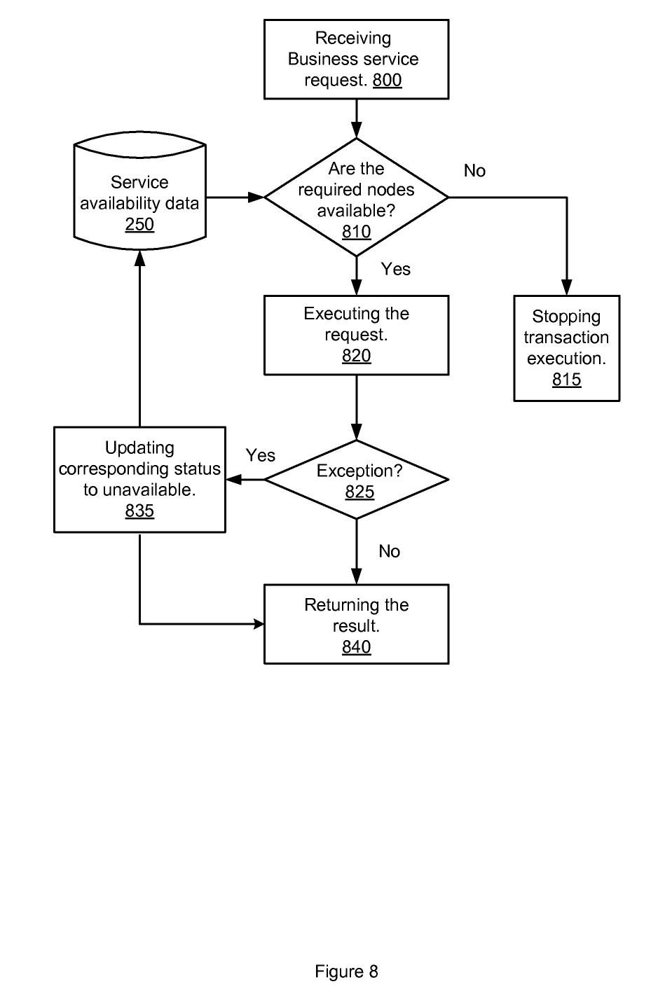

The server 12 may be described in the context of executable instructions, such as a program, or more specifically, an operating system (OS) 40 that is an aggregate of program modules 42 being executed by the central processing unit (CPU) 16 to control the operation of the server 12. The program modules 42 may perform particular tasks of the OS 40, such as process management, memory management, and device management. The program modules 42 may be implemented as routines, programs, objects, components, logic, or data structures, for example. The program modules 42 performing the particular tasks may be grouped by function, according to the server 12 component that the program modules 42 control. At least a portion of the program modules 42 may be specialized to execute the algorithm of FIG. 8.

In a distributed computing environment, such as a cloud computing environment, each participating server 12 may be under the control of an OS 40 residing on each local and remote server 12, respectively. In a virtual machine, also referred to as a virtual server, each instance of the virtual machine is an emulation of a physical computer. A physical computer may host multiple virtual machine instances, each sharing the hardware resources of the physical computer, and each emulating a physical computer. Each of the virtual machine instances is under the control of an OS 40.

As shown in FIG. 1, the components of the server 12 may include, but are not limited to, one or more CPUs 16, a system memory 28, and a bus 18 that couples various system components, such as the system memory 28, to the CPU 16.

System memory 28 can include computer system readable media in the form of volatile memory, such as random access memory (RAM) 30 and/or cache memory 32. The server 12 may further include other removable/non-removable, volatile/non-volatile computer system storage media.

By way of example only, a storage system 34 can be provided as one or more devices for reading from and writing to a non-removable, non-volatile magnetic media, such as a hard disk drive (HDD) or an optical disk drive such as a CD-ROM, DVD-ROM. Each device of the storage system 34 can be connected to bus 18 by one or more data media interfaces. The program modules 42, the OS 40, and one or more application programs may be stored on the storage system 34 and subsequently loaded into memory 28 for execution, as needed.

The server 12 may also communicate with one or more external devices 14 such as a keyboard, a pointing device, a display 24, etc.; one or more devices that enable a user to interact with the server 12; and/or any devices (e.g., network card, modem, etc.) that enable the server 12 to communicate with one or more other computing devices. Such communication can occur via I/O interfaces 22.

The server 12 can communicate with one or more networks such as a local area network (LAN), a general wide area network (WAN), and/or a public network (e.g., the Internet) via a network adapter 20. As depicted, the network adapter 20 communicates with the other components of the server 12 via bus 18. However, in a multi-tenant datacenter (MTD) environment, such as a cloud computing environment, network communications may be routed through the member servers 12 and virtual machines through both physical devices (e.g., network adapters network switches), and virtualized networks, such as those implemented using software defined networking (SDN).

It should be understood that although not shown, other hardware and/or software components could be used in conjunction with the server 12. Examples include, but are not limited to: microcode, device drivers, redundant processing units, external disk drive arrays, RAID systems, tape drives, and data archival storage systems, etc.

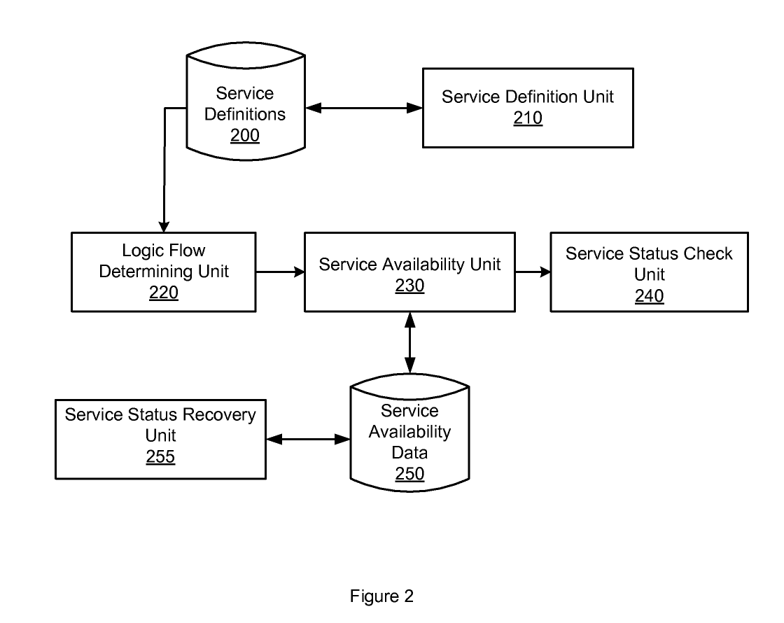

FIG. 2 illustrates an exemplary component diagram of a transaction rollback avoidance framework (framework). Rollback of a transaction containing remote, or external, services may be more complex than for that of a transaction containing local, or internal, services because coordination is required, typically across multiple networks, among the several services participating in the transaction. A service may be considered remote if it is provided by an external service relative to the merchant or website that is providing the main transaction. A service may be considered local if it is provided by an internal service relative to the merchant or website that is providing the main transaction. For example, a credit card payment service may be considered a remote service to the online merchant.

Some services, such as credit card payment services, may not be reversible, meaning they cannot be rolled back. Some others, such as ReserveInventory, may be reversible, but at a high performance and/or financial cost. Although some services, such as a CheckInventory, are read-only and therefore do not require being rolled back, they still need an orderly termination when the parent transaction fails. Transaction compensation is a typical solution for non-reversible services. For example, where an online purchase transaction fails prior to completion, the merchant may have incurred a fee from the credit card servicer for generating a payment. However, reversing the payment may require invoking the credit card service again with a parameter to refund payment. In this example of a compensating transaction, the online merchant may have incurred the cost of two service fees without having actually made a sale.

The framework provides a dynamic check on service availability based on runtime contextual parameters, thereby forecasting executability based on checking the status of services in advance of calling them. Ending the transaction as early as possible once a negative result is forecast may reduce the cost of exception handling, such as transaction compensation or manual operations. Additionally, the cost of unnecessary calls to externals systems for both successful and failed services may be reduced. The framework may be used to coordinate both remote and local services, and may be used to manage logic flows within single transactions or coordinate services among a sequence of transactions.

### Service Definition Unit

The service definition unit 210 receives framework-dependent data required to register, delete, and update service definitions. Service definition data may be entered using any data entry means, such as through a graphical user interface, and may be stored in any data storage format, such as service definitions 200 stored in the storage subsystem 34 (FIG. 1). The format of a service definition is flexible and customizable, and may include input and output parameters associated with the service.

A service definition is a declaration of a remote or local service or subsystem whose status may impact the transaction executing in the framework. The service definition is global to the transaction and includes a checkpoint declaration to enable the system managing the transaction to update the status of the correct service if the service fails. The checkpoint may be registered, for example, by explicit coding or annotating at the point in the source code where the service is invoked. In another embodiment, the service may be registered without modifying the source code by specifying the point where the service is invoked, for example, using an aspect-oriented programming (AOP). AOP is a programming paradigm that attempts to increase modularization in software systems by identifying and isolating cross-functionality.

The service definition may be a record, a table entry, or similar, that identifies the application programming interface (API) where the checkpoint is queried. A service definition may be defined with context, such as a parameter that defines the behavior of the service at execution time. Service invocations with different categories of parameters may be defined as different services. For example, in Table 1, the framework recognizes the CheckExternalInventory service as a different service for each value of catentryId. In another example, the framework recognizes the ProcessPayment service as the same service if the card type is ACard or BCard, but as another service if the card type is CCard. While a Service Identifier, Service Provider and Parameter, if any, are shown in Table 1, the service definition is flexible and customizable, depending upon the framework implementation and the logic flow requirements, for example.

TABLE 1
Service Registration Table

| | Service | |
|---|---|---|
| Service Identifier | Provider | Parameter |
| ProcessInventory | Pricing | |
| CheckExternalInventory | Inventory | catentryId |
| CheckInternalinventory | Inventory | |
| ProcessPayment | Payment | cardType={{ACard,BCard}{CCard}}, |
| | | paymentAction |

Services may also be defined as a hierarchy when different granularity is required. For example, an Inventory external system may have the service hierarchy as in Table 2, where ReserveInventory requires either ReserveInventory_W or ReserveInventory_S depending on processing logic and a set of parameters.

TABLE 2
Service Registration Table Using Hierarchy

| Inventory | ReserveInventory | ReserveInventory_W | ReserveInventory_W(Set1) |
|---|---|---|---|
| | | | ReserveInventory_W(Set2) |
| | | ReserveInventory_S | |
| | CheckInventory | CheckInventory_W | CheckInventory_W(Set1) |
| | | | CheckInventory_W(Set2) |
| | | CheckInventory_S | |

### Logic Flow Determining Unit

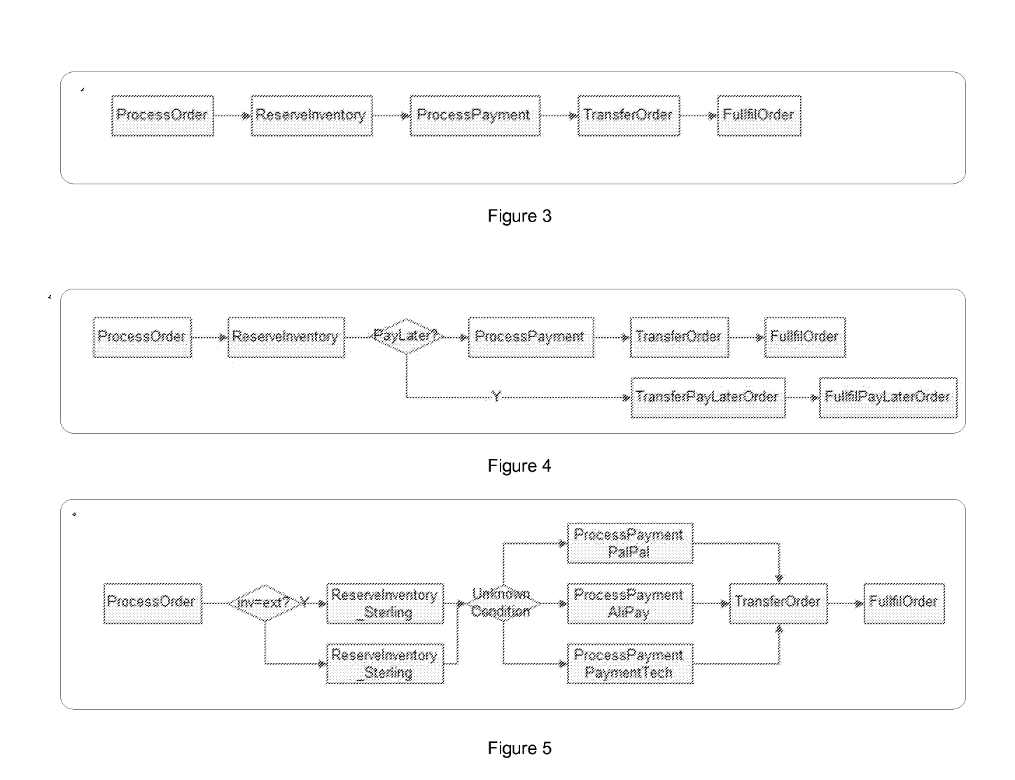

The logic flow determining unit 220 receives service definitions 200 from the service definition unit 210 and organizes them to construct the logic flows in the transaction. For example, FIGS. 3-5 illustrate possible paths for the ProcessOrder logic flow, depending upon how the services in ProcessOrder were registered. Once constructed, the logic flows are input to the service availability unit 230 which checks the availability status of the services and systems in the logic flow in advance of attempting their execution.

Logic flows are constructed from service definitions 200 which correspond to remote or local services or subsystems and are represented by a chain, such as in FIG. 3 or as a tree, as in FIG. 4. In typical operation, the framework is designed and implemented during development of the transaction or logic flow. The framework may be added to an existing system, but in this case, service trees and logic flows may be generated using output from available source code scanning tools. However, as shown in FIG. 5, the code scan approach may be unable to determine runtime entry conditions, such as where a value determines the class instance, and a branch for each potential implementation is then created. In FIG. 5, the ProcessOrder logic flow enters one of three instances of ProcessPayment, depending on the entrance condition parameter of PalPal, AliPay, or PaymentTech.

### Service Availability Unit

The service availability unit 230 maintains the availability status of services and systems registered as service definitions 200 and organized into logic flows by the logic flow determining unit 220. The service availability unit 230 catches exceptions, in real time, at the registered service definition points, and updates the service availability data 250. The service availability data 250 may subsequently be queried by the service status check unit 240 to forecast the success of the logic flow based on at least one path through the registered checkpoints being available. For example, in Table 3 when the service availability unit 230 catches an exception in the ProcessPayment service of the ProcessOrder logic flow, the ProcessPayment status is marked unavailable while processing OrderID=12 due to Communication Failure, possibly between the local system and the external service provider. The format of the service availability data is customizable, depending on the business needs of the framework implementation.

TABLE 3
Service Availability Status

| | Avail- | | Failing | |
|---|---|---|---|---|
| Service | ability | Pro- | Parameter | |
| Identifier | Status | vider | Set | Error |
| ReserveInventory | Y | Inven- | | |
| | | tory | | |
| ProcessPayment | N | Pay- | OrderID=12 | Communi- |
| | | ment | | cation |
| | | | | Failure |
| FulfillOrder | Y | Ware- | | |
| | | house | | |

### Service Status Check Unit

When a logic flow, as constructed by the logic flow determining unit 220, is executing, the service status check unit 240 may proactively check the service availability data 250, as maintained by the service availability unit 230, to forecast the success of the logic flow based on at least one path through the registered checkpoints being available. Service status checks may be performed at entering a logic flow, or status may be checked at the entrances of branches of the logic flow at runtime. In either case, the transaction may be stopped as early as possible when a branch is not executable. Service status checks may be performed according to customizable policies.

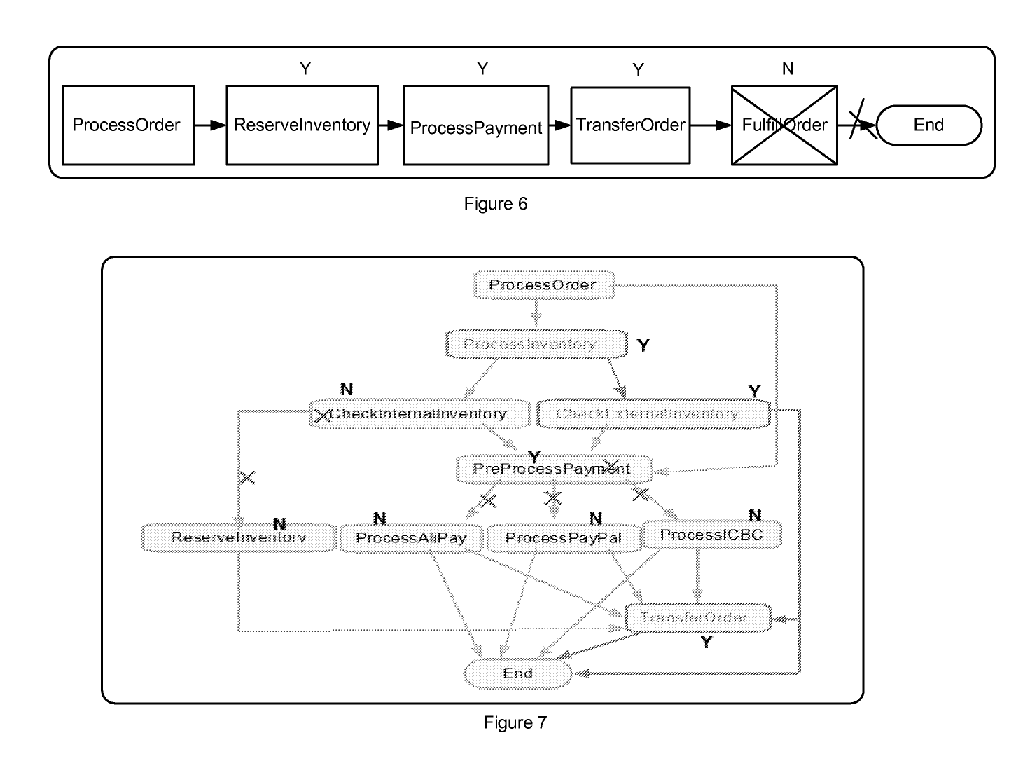

A simple logic flow may predict a failure if any of the dependent services is marked as unavailable. In FIG. 6, for example, the ProcessOrder logic flow is predicted to fail because it has a dependency on the FulfillOrder service which is unavailable. A more complex policy may provide that the logic flow predicts a failure if any of the dependent services has failed with specific error codes, such as “Communication Failure” as in the example of Table 3. Another complex policy may provide a mapping between the parameters at registered checkpoints and the runtime values. For example, in Table 4 the service status check unit 240, using the service availability data 250, may predict a failure for the ProcessPayment service when invoke with a cardType=ACard, but a success is predicted when the ProcessPayment service is invoked with a cardType=BCard.

TABLE 4
Service Availability Data

| | Avail- | | | |
|---|---|---|---|---|
| Service | ability | | | |
| Identifier | Status | Provider | Error | Last Update |
| ProcessPayment | N | Payment | System Not | 2013-08-08 |
| cardType=ACard | | | Available | 10.02.25.00 |
| ProcessPayment | Y | Payment | | 2013-08-08 |
| cardType=BCard | | | | 10.02.25.00 |

FIG. 7 illustrates another view of the ProcessOrder logic flow, first introduced in FIG. 5. Here, the actual execution path of the branches may not be determined until a runtime entry condition determines the class instance. The only available paths through the ProcessOrder logic flow are:

ProcessInventory>CheckExternalInventory>TransferOrder>End

ProcessInventory>CheckExternalInventory>End

In this example, the ProcessOrder logic flow can predict failure if any other branch is attempted, since paths through the other services are marked as unavailable.

### Service Status Recovery Unit

When services previously marked as unavailable are resumed, the service status recovery unit 255 updates the service availability data 250 for use by the service availability unit 230 and service status check unit 240. In one embodiment, a configurable number of monitor threads may be scheduled to periodically test and update the availability for the services in the service availability data 250. The monitor threads may test each service on a configurable attempt interval, such as a number of seconds. Each service may be may be configured with its own customizable attempt interval, depending, for example on how frequently the service is called. The framework may automatically adjust the attempt intervals based on how frequently the service is called. For example, if a ReserveInventory service is defined for each product for sale on the merchant's website, and a product has a high reservation rate, such as a number of reservations per hour, then if the ReserveInventory service fails for that product, the service status recovery unit 255 may decrease the attempt interval to increase the monitoring frequency. As shown in Table 5, the service availability data 250, is enhanced to include attempt interval, service call frequency, and a timestamp representing the last update to the service status.

TABLE 5
Enhanced Service Availability Data

| | Availability | | | Call | | Attempt |
|---|---|---|---|---|---|---|
| Service Identifier | Status | Provider | Error | Frequency | Last Update | Interval |
| ProcessPayment | N | Payment | System | 20 | 2013-08-08 | 180 |
| cardType = ACard | | | Not | | 10.02.25.00 | |
| | | | Available | | | |
| ProcessPayment | Y | Payment | | 11 | 2013-08-08 | 180 |
| cardType = BCard | | | | | 10.02.25.00 | |
| ReserveInventory | Y | Warehouse | | 40 | 2013-08-08 | 60 |
| | | | | | 10.02.25.00 | |

In another embodiment, an unavailable service may self-report that the service is resumed, for example by triggering an exception process to contact the service status recovery unit 255. Alternatively, the service status may be manually updated, for example by a systems administrator using a graphical user interface.

FIG. 8 illustrates a flowchart of a method for avoiding a transaction rollback according to embodiments of the present disclosure. At 800 the framework receives a request to execute a business service from a transaction. At 810 the service status check unit 240, using the service availability data 250, proactively checks the availability of the services, also referred to as nodes, along the logic flow. If at least one path through the logic flow is available, then at 820 the service request is executed because successful completion is forecast. However, when no path is available, the transaction is stopped at 815. In a sample algorithm illustrated in FIG. 7, to determine whether there is an executable path to a service, for each unavailable path, the path to the service is marked as unavailable. For each service if all outgoing paths are unavailable, then the service is marked unavailable. While executing, if the service completes at 825 the result is returned at 840. However, if the service fails at 825, the service availability unit 230 may catch the exception and update the service availability data 250. At 810 the transaction may continue if the service status check unit 240 determines that there is at least one path through the logic flow.

Various embodiments implementing the method of the present invention have been described above with reference to the accompanying drawings. Those skilled in the art may understand that the method may be implemented in software, hardware or a combination of software and hardware. Moreover, those skilled in the art may understand that by implementing various steps in the above method in software, hardware or a combination of software and hardware, there may be provided an apparatus for avoiding a transaction rollback based on the same inventive concept. Even if the apparatus has the same hardware structure as a general-purpose processing device, the functionality of software contained therein makes the apparatus manifest distinguishing properties from the general-purpose processing device, thereby forming an apparatus of the various embodiments of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for avoiding transaction rollback, comprising:
determining, by a service status check unit, whether at least one available path exists through a logic flow during an execution of a transaction;
forecasting, by the service status check unit, a successful logic flow completion based on the determined existence of at least one available path through the logic flow; and
terminating the transaction, based on no available path through the logic flow.

2. The method of claim 1, further comprising:
registering, by a service definition unit, one or more services in the transaction, wherein the registered service includes at least one of: a service identifier, a service provider, a checkpoint, an application programming interface, and one or more context parameters.

3. The method of claim 1, further comprising:
analyzing, by the logic flow determining unit, the one or more context parameters, to determine runtime entry conditions for the registered service;
constructing, by the logic flow determining unit, the logic flow from the one or more registered services, based on the determined runtime entry conditions, wherein the logic flow is the logical order of execution of the one or more registered services, and wherein the one or more logic flows comprise a transaction.

4. The method of claim 1, further comprising:
intercepting, by a service availability unit, an exception during the execution of the registered service;
updating, by the service availability unit, service availability data in response to the registered service changing a status to unavailable; and
marking a service unavailable when no available paths to the registered service exist in the currently executing logic flow.

5. The method of claim 1, further comprising:
monitoring, by a service status recovery unit, the status of the one or more registered services; and
updating, by the service status recovery unit, the service availability data in response to the unavailable registered service being resumed, and in response to a previously available registered service being unavailable.

6. The method of claim 5, wherein the monitoring of each service is performed on at least one of: a configurable attempt interval, and an automatically adjustable attempt interval, wherein the adjustable attempt interval is based on a frequency of the transaction calling the registered service.

7. The method of claim 1, further comprising:
for each unavailable path, marking the path to the registered service as unavailable; and
for each registered service, marking the registered service unavailable, based on all outgoing paths from the registered service being unavailable.

8. A computer program product for avoiding transaction rollback comprising a computer readable storage medium readable by a processing circuit and storing instructions for execution by the processing circuit for performing a method comprising:
determining, by a service status check unit, whether at least one available path exists through a logic flow during an execution of a transaction;
forecasting, by the service status check unit, a successful logic flow completion based on the determined existence of at least one available path through the logic flow; and
terminating the transaction, based on no available path through the logic flow.

9. The computer program product of claim 8, further comprising:
registering, by a service definition unit, one or more services in the transaction, wherein the registered service includes at least one of: a service identifier, a service provider, a checkpoint, an application programming interface, and one or more context parameters.

10. The computer program product of claim 8, further comprising:
analyzing, by the logic flow determining unit, the one or more context parameters, to determine runtime entry conditions for the registered service;
constructing, by the logic flow determining unit, the logic flow from the one or more registered services, based on the determined runtime entry conditions, wherein the logic flow is the logical order of execution of the one or more registered services, and wherein the one or more logic flows comprise a transaction.

11. The computer program product of claim 8, further comprising:
intercepting, by a service availability unit, an exception during the execution of the registered service;
updating, by the service availability unit, service availability data in response to the registered service changing a status to unavailable; and
marking a service unavailable when no available paths to the registered service exist in the currently executing logic flow.

12. The computer program product of claim 8, further comprising:
monitoring, by a service status recovery unit, the status of the one or more registered services; and
updating, by the service status recovery unit, the service availability data in response to the unavailable registered service being resumed, and in response to a previously available registered service being unavailable.

13. The computer program product of claim 12, wherein the monitoring of each service is performed on at least one of: a configurable attempt interval, and an automatically adjustable attempt interval, wherein the adjustable attempt interval is based on a frequency of the transaction calling the registered service.

14. The computer program product of claim 8, further comprising:
for each unavailable path, marking the path to the registered service as unavailable; and
for each registered service, marking the registered service unavailable, based on all outgoing paths from the registered service being unavailable.

15. A computer system for avoiding transaction rollback comprising a memory, a processing unit communicatively coupled to the memory, and a management module communicatively coupled to the memory and processing unit, wherein the management module is configured to perform the steps of a method comprising:
determining, by a service status check unit, whether at least one available path exists through a logic flow during an execution of a transaction;
forecasting, by the service status check unit, a successful logic flow completion based on the determined existence of at least one available path through the logic flow; and
terminating the transaction, based on no available path through the logic flow.

16. The computer system of claim 15, further comprising:
registering, by a service definition unit, one or more services in the transaction, wherein the registered service includes at least one of: a service identifier, a service provider, a checkpoint, an application programming interface, and one or more context parameters.

17. The computer system of claim 15, further comprising:
analyzing, by the logic flow determining unit, the one or more context parameters, to determine runtime entry conditions for the registered service;
constructing, by the logic flow determining unit, the logic flow from the one or more registered services, based on the determined runtime entry conditions, wherein the logic flow is the logical order of execution of the one or more registered services, and wherein the one or more logic flows comprise a transaction.

18. The computer system of claim 15, further comprising:
intercepting, by a service availability unit, an exception during the execution of the registered service;
updating, by the service availability unit, service availability data in response to the registered service changing a status to unavailable; and
marking a service unavailable when no available paths to the registered service exist in the currently executing logic flow.

19. The computer system of claim 15, further comprising:
monitoring, by a service status recovery unit, the status of the one or more registered services; and
updating, by the service status recovery unit, the service availability data in response to the unavailable registered service being resumed, and in response to a previously available registered service being unavailable.

20. The computer system of claim 19, wherein the monitoring of each service is performed on at least one of: a configurable attempt interval, and an automatically adjustable attempt interval, wherein the adjustable attempt interval is based on a frequency of the transaction calling the registered service.
